(19) United States
(12) Patent Application Publication
(10) Pub. No.: US 2014/0359181 A1
(43) Pub. Date: Dec. 4, 2014

(54) Delaying Bus Activity To Accomodate Memory Device Processing Time

(71) Applicant: Hewlett-Packard Development Company, L.P., Houston, TX (US)

(72) Inventor: Melvin K. Benedict, Magnolia, TX (US)

(21) Appl. No.: 13/906,375

(22) Filed: May 31, 2013

(51) Int. Cl. G06F 13/16

(52) U.S. Cl. CPC G06F 13/1689
USPC 710/118

(57) ABSTRACT

A technique includes delaying bus activity targeting a memory device and indicating a command for the memory device to allow time for the memory device to complete processing the command. The delaying of the bus activity includes selectively generating an error signal on a memory bus.

### BACKGROUND

A computer system traditionally has contained both volatile and non-volatile storage devices. In this manner, due to their relatively faster access times, volatile memory devices, such as dynamic random access memory (DRAM) devices, typically have been used to form the working memory for the computer system. To preserve computer system data when the system is powered off, data has traditionally been stored in non-volatile mass storage devices associated with slower access times, such as magnetic media-based or optical media-based mass storage devices.

The development of relatively high density, solid state non-volatile memory technologies is closing the gap between the two technologies, and as such, non-volatile memory devices are becoming increasingly used for both traditional “memory” and “storage” functions.

### BRIEF DESCRIPTION OF THE DRAWINGS

FIG. 1 is a schematic diagram of a computer system according to an example implementation.

FIGS. 2 and 8 are flow diagrams depicting techniques to delay bus activity to accommodate time for a memory device to process a command according to example implementations.

FIG. 3 is a schematic diagram of a memory subsystem of the computer system of FIG. 1 according to an example implementation.

FIGS. 4, 5, 6 and 7 are waveforms of signals communicated over the memory bus of FIG. 3 according to an example implementation.

### DETAILED DESCRIPTION

Some non-volatile memory devices, such as non-volatile memory devices from emerging technologies (flash-based random access memory (RAM), phase change memory and memristor technologies, as examples) may have access times that are significantly slower than the access times of traditional volatile memory devices, such as dynamic random access memory (DRAM) devices. Due to the access time differences, it may be challenging to communicate with mixed memory technology devices (such as non-volatile and volatile memory devices) that are coupled to the same memory bus.

In this manner, incorporating non-volatile and volatile memory devices on the same memory bus may be challenging because the timing specifications of the memory bus may be deterministic in nature, in that commands that are communicated via the memory bus to memory devices are expected to be completed in order and within certain times. Meeting these specifications may be particularly challenging when the memory devices have significantly disparate timing properties.

As a more specific example, for a read operation for a double data rate (DDR) memory bus, the memory device that is the target of the read operation may be expected to respond to a read command within a minimum column address strobe latency (CL) (a specified number of cycles for the bus clock signal, for example). A non-volatile memory bus device may be incapable, however, of responding to a read command within the specified CL time.

Systems and techniques are disclosed herein for purposes of communicating with both volatile and non-volatile memory devices that are coupled to the same memory bus and have significantly disparate timing properties. More specifically, systems and techniques are disclosed herein for purposes of communicating commands to both volatile and non-volatile memory devices of a computer system over a memory bus (shared in common with the devices) that has at least one deterministic timing specification that may be met by relatively high speed volatile memory devices but may not be met by relatively slow, non-volatile memory devices.

In accordance with some implementations, the non-volatile memory device is constructed to selectively assert an error signal on the memory bus to interject a delay to allow the non-volatile memory device more time to process a given command. In this manner, assertion of the error signal halts the bus operation associated with the command and eventually causes the memory controller to replay the operation. The time in which the error signal is asserted combined with the time for the operation to replay allow more time for the non-volatile memory bus to process the command (retrieve data from its memory array and furnishes the data at its data output terminals, for example); and as a result, the non-volatile memory device may timely respond to the replayed operation and effectively meet the timing specifications for the memory bus.

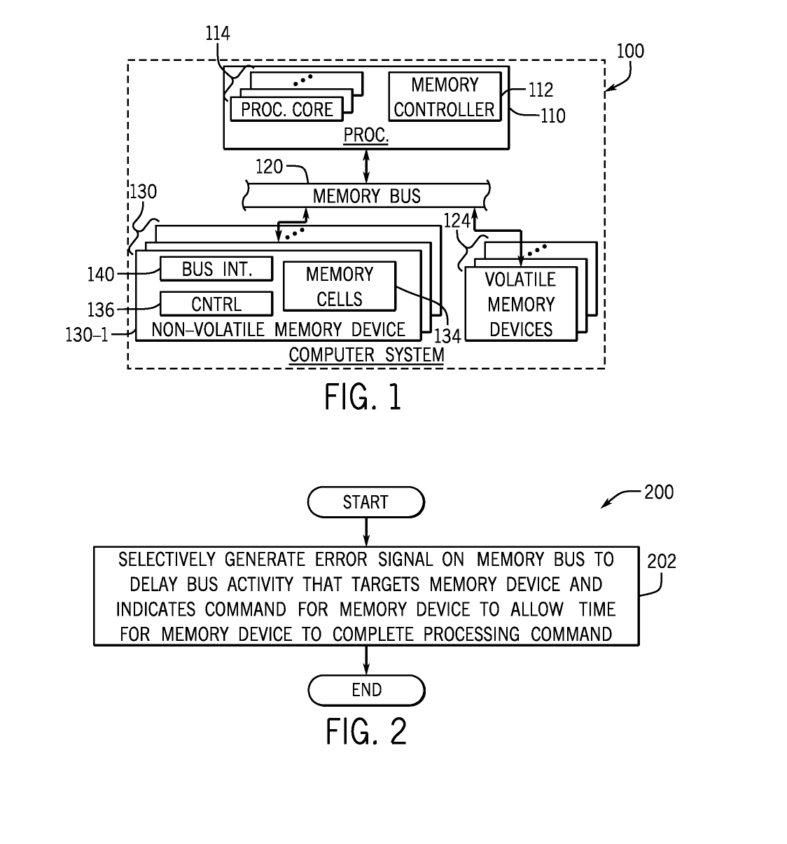

As a more specific example, FIG. 1 depicts a computer system 100 in accordance with an example implementation. For this example, the computer system 100 includes volatile memory devices 124, such as, for example, double data rate (DDR) synchronous dynamic random access memory (SDRAM) memory devices, which are coupled to a memory bus 120 (a DDR SDRAM memory bus, for example). In general, the memory bus 120 may be any DDRx bus (a DDR3 or DDR4 bus, for example), and the volatile memory devices 124 may have corresponding DDRx interfaces. For such purposes as storing data in and retrieving data from the volatile memory devices 124, activating memory cell rows of the volatile memory devices 124 and so forth, a memory controller 112 of the computer system 100 may selectively assert and deassert control, address and data signals on the memory bus 120 to generate corresponding bus cycles, or operations, on the memory bus 120.

For the specific example of FIG. 1, the memory controller 112 is part of a processor 110. In this manner, the processor 110 may be, for example, a semiconductor-based central processing unit (CPU) package, which includes one or multiple processing cores 114, along with the memory controller 112. It is noted that the computer system 100 is simplified in FIG. 1, as the computer system 100 may include one or multiple such processing packages 110, depending on the particular implementation. Moreover, in accordance with further implementations, the memory controller 112 may be disposed in a semiconductor package, which is separate from any processing core. Thus, many implementations are contemplated, which are within the scope of the appended claims.

In addition to the volatile memory devices 124, the computer system 100 for this example includes one or multiple non-volatile memory devices 130, such as example non-volatile memory device 130-1. The non-volatile memory device 130-1 may have a DDRx interface, in accordance with an example implementation. As an example, the volatile memory devices 124 may be SDRAM-based, dual inline memory modules (DIMMs); and the non-volatile memory device 130 may be, as examples, flash-based RAM, phase change or memristor modules.

Regardless of the specific memory types, for this example, the volatile 124 and non-volatile 130 memory devices are coupled to the memory bus 120. Thus, data may be written to and retrieved from the volatile 124 and non-volatile 130 memory devices via bus operations on the memory bus 120.

Memory cells 134 of the non-volatile memory device 130-1 may, in general, have an associated slower access time, as compared to the time to access memory cells of a given volatile memory device 124. As a result, the non-volatile memory device 130-1 may experience longer times in storing data in and retrieving data from its memory cells 134. The memory bus 120, may be governed by a set of minimum timing specifications that are specifically tailored for the relatively faster access times of the volatile memory devices 124. Moreover, the memory bus 120 may be a deterministically-timed bus, which is governed by a specification that does not provide a delay command or other explicit mechanisms to the introduction of a delay for purposes of accommodating a relatively slower memory device, such as the non-volatile memory device 130-1 for this example.

As a more specific example, in accordance with an example implementation, the memory bus 120 may be a DDR SDRAM memory bus, which is a deterministic interface that allows no provisioning for the delaying of a command. In general, the specification for the DDR SDRAM bus 120 prescribes that all commands are completed in order and with prescribed minimum time(s).

In accordance with example implementations, the memory device 130 includes a bus interface 140 that is coupled to the memory bus 120 for purposes of decoding signals from the memory bus 120 and furnishing encoded signals to the memory bus 120 to communicate data to and from the memory device 130-1. Thus, via this mechanism, the memory device 130-1 may, for example, receive various commands, such as commands to write data, read data, activate a given row, and so forth. Due to its relatively slow access time, however, the memory device 130 may be incapable of keeping up with the rate at which commands are communicated over the memory bus 120. To accommodate the timing disparity, the memory device 130 includes a controller 136, which selectively generates an error signal on the memory bus 120 to effectively generate a delay to provide more time for the memory device 130 to process a given command.

In particular, in accordance with an example implementation, the memory controller 112 responds to the assertion of the error signal to temporarily halt, or cease, the current bus activity. For example, in accordance with example implementations, the memory controller 112 halts the current bus operation in response to the assertion of the error signal and replays the bus operation when the error signal is de-asserted.

Thus, referring to FIG. 2 in conjunction with FIG. 1, in accordance with an example implementation, a technique 200 includes selectively generating (block 202) an error signal on a memory bus to delay bus activity on the memory bus that targets a memory device and indicates a command for memory device to allow time for the memory device to complete processing the command.

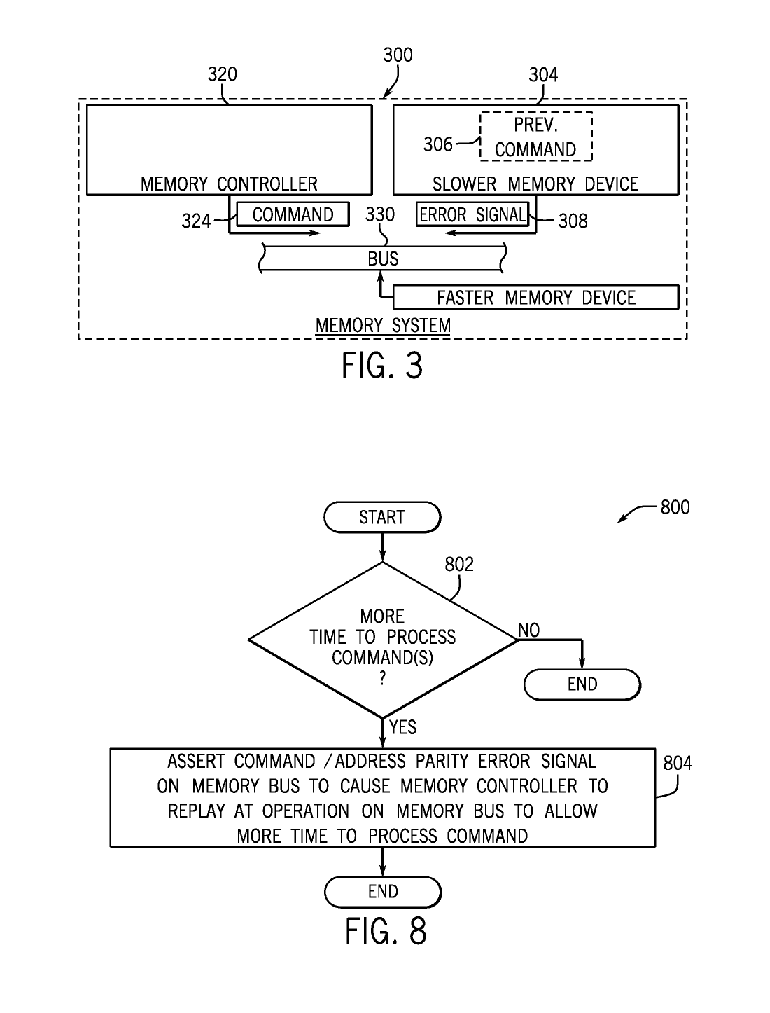

Referring to FIG. 3, to summarize, a memory subsystem 300 in accordance with an example implementation includes a memory controller 320 that generates a command 324 on a bus 330, which targets a given memory device 304. For this example, however, the memory device 304 needs more time to process the command 324 that the time allocated by the bus' timing specification(s). Therefore, the memory device 304 asserts an error signal 308, which causes the memory controller 320 to replay at least the command 324, thereby allowing the memory device 304 to be used in conjunction with other memory devices, such as exemplary faster memory device 305, which has a faster access time and does not use this delay mechanism.

Referring back to FIG. 1, as a more specific example, in accordance with some implementations, the error signal may be parity error signal, which is a signal that is otherwise used to indicate command and address parity errors on the memory bus 120. In this manner, the memory bus 120 may have a defined command/address parity check function; and this function may normally be used to selectively assert a parity error signal. More specifically, multi-bit commands and addresses that appear on the memory bus 120 are assumed to be valid for odd parities and invalid for even parities. For example, the logic ones and zeros indicated by a given command may be added to form a checksum, and if the checksum is even, then the command is deemed to be invalid (i.e., an error condition for which the parity error signal is asserted). In this regard, an even parity is deemed to indicate an invalid command, even if the bits otherwise indicate what appears to be a valid command, as the wrong command may be indicated. Alternatively, even parity may be due to the command bits indicate a non-existent (and thus, invalid) command. Likewise, an even parity for address bits is deemed to indicate an invalid address, whereas an odd parity is deemed for the address bits is deemed to indicate a valid address.

When the parity error signal is asserted on the memory bus 120, the memory controller 112 responds to the assertion by halting the current bus operation and ceasing further bus activity until the parity error signal is de-asserted. For a DRAM device asserting the parity error signal, the DRAM device returns to a pre-charged state and asserts the error signal for the duration of time that the memory device takes to transition to the pre-charged state and either resumes command execution or alternatively, wait until the error status is cleared prior to resuming command execution (depending upon a mode register bit of the DRAM device).

A memory control policy, called a “closed page” policy is defined, in accordance with example implementations, which forces command sequences to a predetermined set. In this manner, in accordance with example implementations, read and write operations have the following sequence: activate, and then read/write with auto pre-charge, which leaves the memory cell array in a known state at the end of the command sequence. Therefore, the next command may be forced to retry (via the assertion of the parity error signal) without significance performance penalty and without endangering the contents of the memory. Thus, by using the selective generation of the parity error signal and this memory control policy, the non-volatile memory device 130 may interject delays may be inserted in the otherwise deterministic DDR interface.

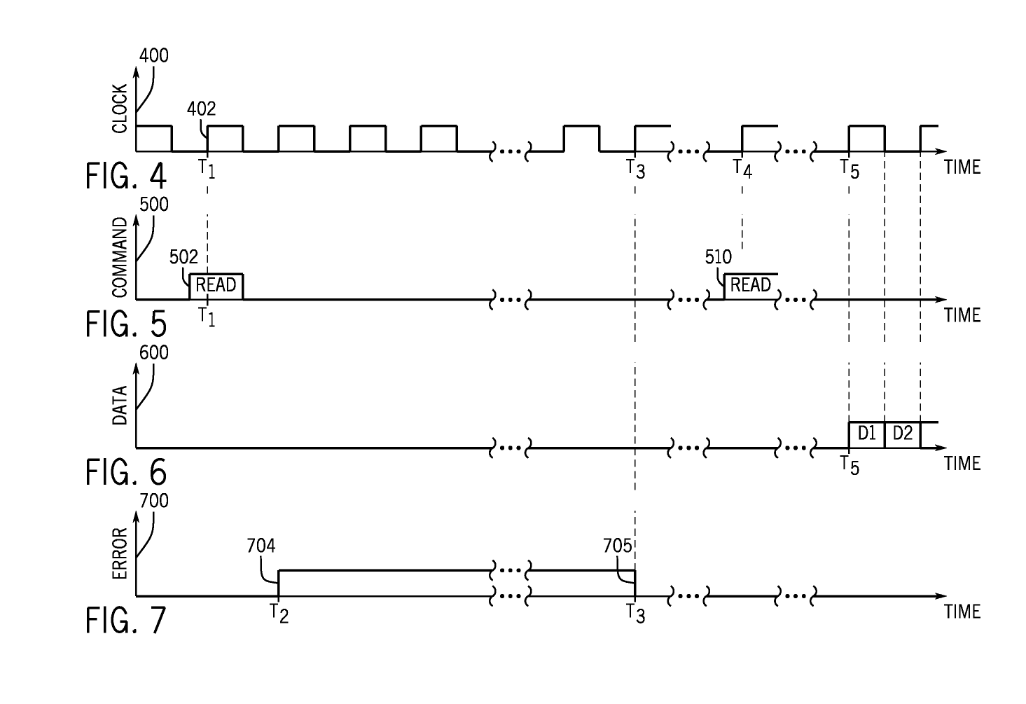

Thus, referring to FIGS. 4 (depicting a clock waveform 400), 5 (depicting a read command 500), 6 (data 600) and 7 (depicting a parity error signal 700), as an example, a read operation may occur to read data from the non-volatile memory device 130-1. For this example, coincident with a rising, or positive going edge 402, of the clock signal 400, the appropriate signals are asserted/de-asserted on the memory bus to indicate a read command 502 at time T₁. The memory device 130-1 decodes the read command 502 and needs more time than the bus' timing specification allows to process the read command 502. Therefore, the memory device 130-1 asserts the parity error signal 700 at time T₂, as depicted in FIG. 7.

For this example, the memory device 130-1 de-asserts the parity error signal at time T₃, which causes the memory controller 112 to initiate a reply of the read operation, include the furnishing of a read command 510 at time T₄. The memory device 130-1 furnishes data to respond to the replayed read operation beginning at time T₅.

Thus, referring to FIG. 8, in accordance with example implementations, a technique 800 includes a controller of a memory device determining (decision block 802) whether more time is needed to process a command for the memory device. If so, the memory device selectively asserts (block 804) the command/address parity error signal on the memory bus to cause the memory controller to replay at least the bus operation to allow more time for memory device to process command.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
delaying bus activity targeting a memory device and indicating a command for the memory device to allow time for the memory device to complete processing the command;
wherein delaying the bus activity comprises selectively generating an error signal on a memory bus.

2. The method of claim 1, wherein selectively generating the error signal comprises generating a signal to cause a memory controller to replay at least one operation on the memory bus.

3. The method of claim 1, wherein delaying the bus activity further comprises accommodating a timing difference between a rate at which commands may be communicated over the memory bus and a timing at which the memory device processes the commands.

4. The method of claim 1, wherein selectively generating the error signal comprises generating a signal indicative of a parity error on the memory bus.

5. The method of claim 1, wherein delaying the bus activity comprises regulating a timing of commands communicated over a double data rate (DDR) memory bus.

6. The method of claim 1, wherein delaying the activity comprises regulating a time for a non-volatile memory to complete processing of a command.

7. The method of claim 1, further comprising communicating with volatile and non-volatile memory devices over the memory bus.

8. A method comprising:
regulating a time for a memory device to complete processing of a command communicated to the memory device over a memory bus,
wherein the regulating comprises selectively generating a signal to cause a memory controller to replay at least one operation on the memory bus.

9. The method of claim 8, wherein selectively generating the signal comprises selectively generating a parity error signal.

10. The method of claim 8, wherein regulating the time comprises regulating a timing of commands communicated to the memory device over a double data rate (DDR) memory bus.

11. The method of claim 8, further comprising communicating with volatile and non-volatile devices over the memory bus.

12. The method of claim 8, wherein regulating the timing comprises accommodating a timing difference between a rate at which commands may be communicated over the memory bus and a timing at which the memory device processes the commands.

13. A system comprising:
a volatile memory device;
a non-volatile memory device;
a memory bus to communicate commands to the volatile memory device and the non-volatile memory device; and
a memory controller to initiate cycles on the memory bus to communicate the commands, wherein a timing specification of the bus controls a minimum time between the communication of successive commands via the memory bus and the timing specification is independent of time actually consumed by the non-volatile memory device to process a given command communicated to the non-volatile memory device via the memory bus,
wherein the non-volatile memory device is adapted to selectively generate an error signal on the memory bus to delay completion of a bus operation associated with the given command to allow time for the non-volatile memory device greater than the minimum time to process the given command.

14. The system of claim 13, wherein the error signal comprises a signal to cause the memory controller to replay at least one operation on the memory bus.

15. The system of claim 13, wherein the error signal comprises a signal to cause re-communication of the given command.

16. The system of claim 13, wherein the error signal indicates a parity error on the memory bus.

17. The system of claim 13, wherein the memory controller is adapted to initiate double data rate (DDR) cycles on the memory bus.

18. The system of claim 13, further comprises a dual inline memory module comprising the volatile memory.

19. The system of claim 13, wherein the error signal indicates a parity error associated with at least one of a checksum of bit values corresponding to address lines of the memory bus and a checksum of bit values corresponding to data lines of the memory bus.

20. The system of claim 13, further comprising:
a processing core to use the memory controller to initiates cycles on the memory bus to communicate data with the volatile memory device and the non-volatile memory device.
